(19) United States
(12) Patent Application Publication
(10) Pub. No.: US 2021/0051076 A1
(43) Pub. Date: Feb. 18, 2021

(54) A NODE, CONTROL SYSTEM, COMMUNICATION CONTROL METHOD AND PROGRAM

(71) Applicant: NEC Corporation, Minato-ku, Tokyo (JP)

(72) Inventor: Tomoshige FUNASAKI, Tokyo (JP)

(73) Assignee: NEC Corporation, Minato-ku, Tokyo (JP)

(21) Appl. No.: 16/969,343

(22) PCT Filed: Feb. 20, 2019
(86) PCT No.: PCT/JP2019/006310

§ 371 Date: Aug. 12, 2020

(30) Foreign Application Priority Data
Feb. 21, 2018 (JP) 2018-028645

(51) Int. Cl. H04L 12/24; H04L 12/46

(52) U.S. Cl. CPC H04L 41/12; H04L 12/4633

(57) ABSTRACT

A control system is configured by including a control apparatus controlling a virtual network function(s) and includes a first node assigning number to a terminal ID for the terminal in the customer premises network, wherein when the first node receives data whose transmission source or destination is the terminal from outside of the control system, the first node adds, to the received data, terminal information including a terminal ID corresponding to the terminal which is transmission source or destination of the received data and a customer ID for a customer corresponding to the premises network to which the terminal connects, and uses the data added with the terminal information in the control system.

### TECHNICAL FIELD

### Description of the Related Application

The present invention claims the benefit of foreign priority of Japanese Patent Application No. 2018-028645 (filed on Feb. 21, 2018), which is incorporated herein and described by reference in its entirety. The present invention relates to a node, control system, communication control method and program.

### BACKGROUND

Practical application has been considered, too, of a virtual CPE (vCPE; virtual Customer Premises Equipment) in which a communication equipment in customer premises (called pCPE (physical Customer Premises Equipment)) is implemented on a communication carrier side network (carrier side network) as a virtual function.

In the vCPE, a communication carrier side server apparatus grasps a terminal(s) in the customer premises (the terminal(s) connecting to a customer premises network) and provides a service according to the terminal(s) in the premises. Here, the service includes a fire wall, a parental control, control of QoS (Quality of Service), or the like.

Accordingly, it is required that the vCPE grasps the terminal(s) in the customer premises properly.

Patent Literature 1 describes a technology that, when a control apparatus receives a request to issue an authentication key from a user portable terminal via a premises equipment and the vCPE, the control apparatus identifies the portable terminal uniquely based on a MAC (Media Access Control) address.

Patent Literature 2 describes a technology that a gateway apparatus stores in advance a translation table of a terminal identifier and an IP (Internet Protocol) address, and identifies the terminal identifier corresponding to a transmission source IP address included in a packet based on the translation table.

Patent Literature 3 describes a technology of identifying a contract profile for a terminal by using customer ID information. And, Patent Literature 3 describes a technology of selecting an EPC (Evolved Packet Core) core having a proper function set and resource distribution from a plurality of EPC functions on a virtual platform by using contract service information included in the contract profile and information of the resource distribution of the EPC or the like.

### CITATION LIST

### Patent Literature

Patent Literature 1: Japanese Patent kokai Publication No. 2016-057672 A

Patent Literature 2: Japanese Patent kokai Publication No. 2011-071870 A

Patent Literature 3: Japanese Patent kokai Publication No. 2015-154278 A

### SUMMARY

### Technical Problem

Note, disclosures of the above literatures of Citation List shall be incorporated by reference in the present description. Following analyses are made from a point of view of the present invention.

In a network function virtualization (NFV; Network Function Virtualization), a virtual network function (VNF; Virtual Network Function) is operated by using a virtual machine of each function or control.

Here, even if the terminal is identified at an entrance to a network, there is a case where terminal identification information is lost. In this case, the VNF cannot identify the terminal. As a result, the vCPE cannot provide the service according to the terminal in the premises.

In the technology described in Patent Literature 1, the mobile terminal is identified on the basis of the MAC address. However, there is a case where the MAC addresses of the terminals overlap between the customer premises networks. Further, when the vCPE receives data (a packet), there is a case where an Ethernet (registered trade mark) Header including the MAC address is removed. In these cases, in the vCPE, the mobile terminal cannot be identified on the basis of the MAC address.

In the technology described in Patent Literature 2, the terminal is identified on the basis of the IP address of the terminal. However, there is a case where an IPv4 (Internet Protocol version 4) address is used as a private IP address used in the customer premises network. In this case, it is likely that the IP addresses of the terminals overlap between the customer premises networks. If the IP addresses of the terminals overlap between the customer premises networks, it is likely that the vCPE cannot identify the terminal based on the IP address.

Further, when an IPv6 (Internet Protocol version 6) address is allocated to the terminal as the IP address, there is a case where the IPv6 address changes a host for security purposes (ensuring anonymity). When the host of the IP address is changed, it is likely that the vCPE cannot identify the terminal based on the IP address.

In the technology described in Patent Literature 3, in a case where two or more the terminals connect to one customer premises network, it is not possible to identify each of the terminals. Therefore, in the technology described in Patent Literature 3, in a case where two or more of the terminals connect to the one customer premises network, it is not possible to provide a different service to each of the terminals.

Accordingly, it is an object of the present invention to provide a node, control system, communication control method and program, in a virtual CPE, to contribute to distinguish each terminal in the customer premises.

### Solution to Problem

According to a first aspect, a first node is provided. The first node is arranged in a control system configured by including a control apparatus controlling the virtual network function(s).

Further, the first node assigns a number to a terminal ID (identifier) for a terminal in a customer premises network.

Further, when the node receives data whose transmission source or destination is a terminal from outside of the control system, the node adds, to the received data, terminal information including a terminal ID corresponding to the terminal which is transmission source or destination of the received data and a customer ID for a customer corresponding to a premises network to which the terminal connects, and transfers the resultant data added with the terminal information to a node inside of the control system.

According to a second aspect, a second node is provided. The second node is arranged in a control system controlling a virtual network function(s).

Further, when the second node receives, from inside of the control system, data to which terminal information is added, the terminal information including a number-assigned terminal ID for a terminal which is transmission source or destination of data and a customer ID for a customer corresponding to a premises network to which the terminal connects, the second node removes the terminal information from the received data and transfers the resultant data to outside of the control system.

According to a third aspect, a control system is provided. The control system is configured by including a control apparatus controlling a virtual network function(s).

The control system includes a first node that assigns a number to a terminal ID for a terminal in a customer premises network.

When the first node receives data whose transmission source or destination is the terminal from outside of the control system, the first node adds, to the received data, terminal information including the terminal ID corresponding to the terminal which is transmission source or destination of the received data and a customer ID for a customer corresponding to the premises network to which the terminal connects. The control system uses the data added with the terminal information in the control system.

According to a fourth aspect, a communication control method is provided. The communication control method is a method for controlling a control system controlling a virtual network function(s). The control system includes a first node which receives data whose transmission source or destination is a terminal in a customer premises network, from outside of the control system.

The communication control method includes a step of assigning a number to a terminal ID for the terminal.

Further, the communication control method includes a step of generating terminal information including the terminal ID and a customer ID for a customer corresponding to a premises network which is transmission source or destination of the received data.

Further, the communication control method includes a step of adding the terminal information to the received data.

Further, the communication control method includes a step of transferring the resultant data to which the terminal information has been added to a node inside of the control system.

In addition, the method is coupled with a specified machine which is a node arranged in a control system controlling a virtual network function(s).

According to a fifth aspect, a program is provided. The program is a program for causing a computer configured to control a control system controlling a virtual network function(s). The control system includes a first node which receives data whose transmission source or destination is a terminal in a customer premises network from outside of the control system.

The program causes the computer to execute a process of assigning a number to a terminal ID for the terminal.

Further, the program causes the computer to execute a process of generating terminal information including the terminal ID and a customer ID for a customer corresponding to a premises network to which the terminal connects.

Further, the program causes the computer to execute a process of adding the terminal information to the received data.

Further, the program causes the computer to execute a process of transferring the resultant data to which the terminal information has been added to a node inside of the control system.

In addition, the program can be recorded in a computer readable storage medium. The storage medium may be a non-transient medium such as a semiconductor memory, hard disk, magnetic recording medium, optical recording medium, and other medium. The present invention can also be embodied as a computer program product.

### Adbandageous Effect of the Invention

According to the present invention, there are provided a node, control system, communication method and program that contribute to distinguish each terminal in the customer premises. in a virtual CPE

### BRIEF DESCRIPTION OF THE DRAWINGS

FIG. 1 is a diagram for explaining an overview of an exemplary embodiment.

FIG. 2 is a block diagram illustrating an example of overall structure of a communication system 1000 according to the exemplary embodiment.

FIG. 3 is a diagram illustrating an example of information which a customer terminal information database 305 stores.

FIG. 4 is a diagram illustrating an example of information which a storage part 3032 stores.

FIG. 5 is a diagram illustrating an example of information which a storage part 3042 stores.

FIG. 6 is a flowchart illustrating an example of a process recording an application policy.

FIG. 7 is a flowchart illustrating an example of a process transmitting data from a terminal 600 in customer premises via a control system 300.

FIG. 8 is a flowchart illustrating an example of a process transmitting data from a terminal 600 in customer premises via a control system 300.

FIG. 9 is a flowchart illustrating an example of a process transmitting data from a terminal 600 in customer premises via a control system 300.

FIG. 10 is a flowchart illustrating an example of a process which a control system 300 transmits data destined to a terminal in a customer premises.

FIG. 11 is a flowchart illustrating an example of a process which a control system 300 transmits data destined to a terminal in a customer premises.

FIG. 12 is a flowchart illustrating an example of a process which a control system 300 transmits data destined to a terminal in a customer premises.

### DETAILED DESCRIPTION

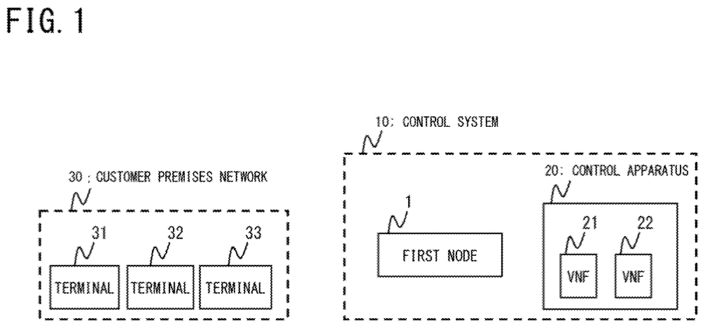

Firstly, an overview of an exemplary embodiment will be explained by using FIG. 1. In addition, drawing reference numerals added to the overview are numerals added to each element as an example for convenience to help the understanding, and the description of the overview is not intended to give any limitation. Further, a connection line between blocks in each block diagram includes both bidirectional and unidirectional. One-way arrow indicates schematically flow of primary signal (data), and does not exclude bidirectionality. In addition, in a circuit diagram, block diagram, internal configuration diagram, connection diagram or the like, though explicit description is omitted, an input port and output port exist an input end and output end of each connection line, respectively. The same applies to an input and output interface, too.

As mentioned above, in a virtual CPE, a control system to contribute to distinguish each terminal in the customer premises is desired.

Therefore, as an example, a control system 10 illustrated in FIG. 1 is provided. The control system 10 is configured by including a first node 1 and control apparatus 20. That is, the first node 1 is arranged in the control system 10. The control apparatus 20 controls VNFs (virtual network functions) (21, 22). In addition, FIG. 1 illustrates two VNFs (21,22) as an example, but this does not mean that a number of the VNFs is limited to two. The number of VNFs controlled by the control apparatus 20 may be one, or three or more.

The first node 1 assigns a number to a terminal ID (identifier) for terminals (31, 32, 33) in a customer premises network 30.

It is assumed that the terminal ID is unique in each of the customer premises networks. Therefore, the terminal ID may overlap between customers. That is, a terminal ID corresponding to a terminal existing in one customer premises may be same as a terminal ID corresponding to a terminal existing in another customer premises.

In addition, FIG. 1 illustrates the three terminals (31, 32, 33) as an example, but this does not mean that a number of the terminals connecting to inside of the customer premises network is limited to three. The number of terminals connecting to the customer premises network may be one, two, or four or more.

Further, the first node 1 receives data from outside of the control system 10. Here, it is assumed that the first node 1 receives, from the outside of the control system 10, the data whose transmission source or destination is the terminal (any one of the terminals 31, 32, 33). That is, it is assumed that the first node 1 receives, from the outside of the control system 10, the data transmitted from a terminal (any one of the terminals 31, 32, 33) in the customer premises network 30 or the data destined to a terminal in the customer premises network 30.

For example, it is assumed that the first node 1 receives the data transmitted from the terminal 31 from outside of the control system 10. In this case, the first node 1 adds terminal information to the received data, the terminal information including a terminal ID corresponding to the terminal 31 which is transmission source of the received data and a customer ID for a customer corresponding to the premise network to which the terminal 31 connects.

The customer ID is information identifying the customer. Here, the customer means a person who has contracted with a communication carrier, with respect to receiving the provision of a communication service. Further, the customer ID is information identifying the customer. For example, the customer ID may be information assigned to the customer by the communication carrier (for example, contract number or the like).

Also, for example, it is assumed that the first node 1 has received the data destined to the terminal 31 from outside of the control system 10. In this case, the first node 1 adds the terminal information to the received data, the terminal information including the terminal ID corresponding to the terminal 31 which is destination of the received data and the customer ID for the customer corresponding to the premises network to which the terminal 31 connects. In the control system 10, the data added with the terminal information is used.

Therefore, in a system realized by using an NFV technology such as the vCPE or the like, it is possible to hold information specifying the terminal in the system realized by using the NFV technology by transferring the data via the first node 1. Accordingly, the control system 10 contributes, in the virtual CPE, to distinguish each of the terminals in the premises.

### FIRST EXEMPLARY EMBODIMENT

It will be explained about a first exemplary embodiment by using figures.

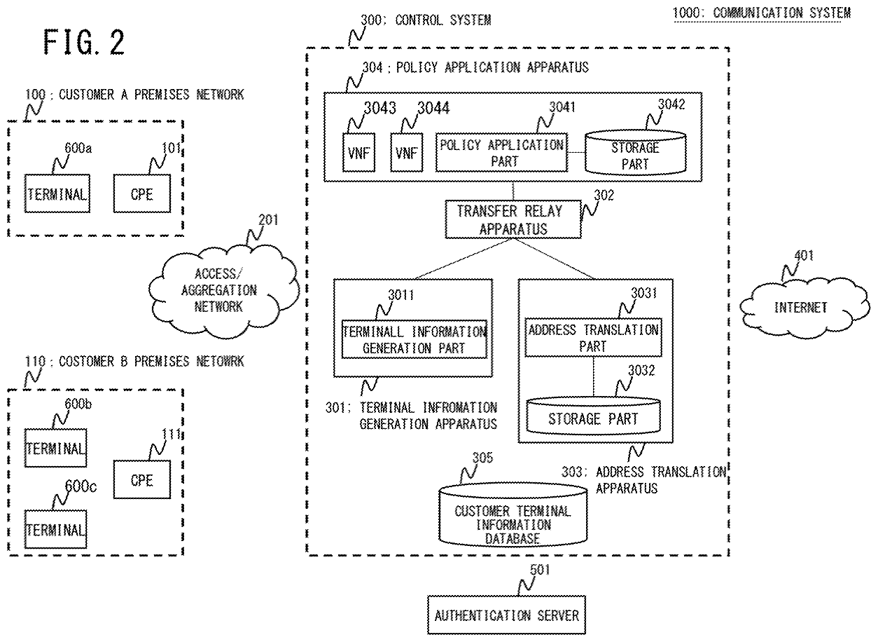

FIG. 2 is a block diagram illustrating an example of overall structure of a communication system 1000 according to this exemplary embodiment. The communication system 1000 is configured by including a control system 300 and an authentication server 501.

The control system 300 formulates the vCPE. That is, the control system 300 realizes a function for a communication equipment in the customer premises as a virtual function on a network. The control system 300 connects to one or more customer premises networks via an access/aggregation network 201. In a following explanation, for convenience of explanation, a terminal 600 connecting to the customer premises network is called “the terminal 600 in the customer premises”.

The control system 300 receives data (a packet) transmitted from the terminal 600 in the customer premises via the access/aggregation network 201, and transfers the data to a designated destination via an internet 401.

A customer A premises network 100 illustrated in FIG. 2 indicates a customer A premises network. A terminal 600a is a PC (Personal Computer), a smartphone, a tablet terminal, or the like used by a user. The terminal 600a comprises a communication function and connects to the customer A premises network. A CPE (Customer Premises Equipment) 101 is a communication equipment (a router or the like) in the customer A premises.

Also, a customer B premises network 110 illustrated in FIG. 2 indicates a customer B premises network. Terminals 600b, 600c are the PC (Personal Computer), smartphone, tablet terminal, or the like used by the user. The terminal 600b comprises a communication function and connects to the customer B premises network 110. A CPE 111 is a communication equipment (a router or the like) in the customer B premises.

The access/aggregation network 201 stores data (packets) transmitted from customer premises networks of each customer (the customer A premises network 100, the customer B premises network 110) and transfers the stored data to the control system 300. Further, the access/aggregation network 201 stores data transmitted from the control system 300 and transfers the data to the premises network of the customer corresponding to destination of the received data.

In the communication system 1000 according to the present exemplary embodiment, the terminals 600 (600a, 600b, 600c) connect to the internet 401 via the access/aggregation network 201 and control system 300.

The authentication server 501 is a server apparatus executing a process authenticating the customer. The authentication server 501 authenticates the customer according to a request for customer authentication. And, when the authentication server 501 authenticates the customer, the authentication server 501 responds the customer ID to a source (requester) of the authentication request.

Next, it will be explained about internal configuration of the control system 300. In addition, in a following explanation, the terminals 600a, 600b, 600c in the customer premises are referred to as “the terminal 600”, as far as it is not necessary to distinguish from one to another.

The control system 300 is configured by including a terminal information generation apparatus 301, a transfer relay apparatus 302, an address translation apparatus 303, a policy application apparatus (a control apparatus) 304, and a customer terminal information database 305. In addition, in the following explanation, data that the control system 300 has received from outside of the control system 300 is called “received data”.

The terminal information generation apparatus 301 is configured by including a terminal information generation part 3011.

A process of the terminal information generation part 3011 may be realized by a program for causing to execute in a processor (CPU (Central Processing Unit)) configuring the terminal information generation apparatus 301. In this case, the program is read from a computer readable medium (a semiconductor memory, a HDD (Hard Disk Drive), or the like) storing the program, and each process is executed by the processor configuring the server apparatus.

The terminal information generation apparatus 301 is a node (first node) which is a boundary between the control system 300 and the access/aggregation network 201.

The terminal information generation part 3011 assigns the number to the terminal ID for the terminal 600 in the customer premises network.

Also, the terminal information generation part 3011 receives the data (the packet) from outside of the control system 300 (the access/aggregation network 201).

It is assumed that the terminal information generation apparatus 301 receives the data whose transmission source or destination is the terminal 600 from outside of the control system 300. In this case, the terminal information generation apparatus 301 adds the terminal information to the received data, the terminal information including the terminal ID corresponding to the terminal 600 which is transmission source or destination of the received data and the customer ID for the customer corresponding to the premises network to which the terminal 600 connects.

Concretely, the terminal information generation part 3011 generates the terminal information including the customer ID and terminal ID. And, the terminal information generation part 3011 adds the generated terminal information to the data transmitted to the terminal 600 in the customer premises.

The terminal information generation apparatus 301 transfers the data added with the terminal information to a node (for example, the transfer relay apparatus 302) in the control system 300. The control system 300 shall use the data added with the terminal information in the control system 300.

Also, it is assumed that the terminal information generation apparatus 301 receives, from inside of the control system 300, the data added with the terminal information, the terminal information including the number-assigned terminal ID for the terminal 600 which is the transmission source or destination of the data and the customer ID for the customer corresponding to the premises network to which the terminal 600 connects. In this case, the terminal information generation apparatus 301 removes the terminal information from the received data and transfers the resultant data to outside of the control system 300 (the terminal 600 in the customer premises).

The customer terminal information database 305 stores in advance the customer ID specifying the customer, the terminal ID corresponding to the terminal 600 in the customer premises network, and a MAC (Media Access Control) address of the terminal 600 corresponding to the terminal ID in association with each other. For example, the customer terminal information database 305 may store a table which associates the customer ID, the terminal ID, and the MAC address of the terminal 600 each other.

The customer terminal information database 305 is realized by using a magnetic disk apparatus, an optical disk apparatus, or the semiconductor memory.

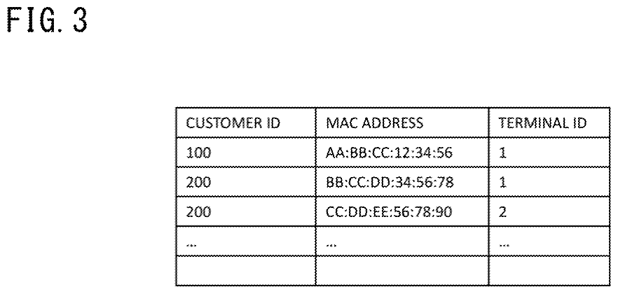

FIG. 3 is a diagram illustrating an example of information which the customer terminal information database 305 stores. FIG. 3 illustrates the table associating the customer ID, the MAC address, and the terminal ID each other.

Here, the customer ID for the customer A is assumed to be “100”. Also, the customer ID for the customer B is assumed to be “200”. Also, the MAC address and terminal ID of the terminal 600a are assumed to be the MAC address “AA:BB:CC:12:34:56” and the terminal ID “1”. Also, the MAC address and terminal ID of the terminal 600c are assumed to be the MAC address “”BB:CC:DD:34:56:78″ and the terminal ID “1”. Also, the MAC address and terminal ID of the terminal 600b are assumed to be the MAC address “CC:DD:EE:56:78:90” and the terminal ID “2”.

FIG. 3 illustrates that the customer terminal information database 305 stores the customer ID “100”, the MAC address “AA:BB:CC:12:34:56”, and the terminal ID “1” in association with each other, with respect to the terminal 600a connecting to the customer A premises network 100. Also, FIG. 3 illustrates that the customer terminal information database 305 stores the customer ID “200”, the MAC address “BB:CC:DD:34:56:78”, and the terminal ID “1” in association with each other, with respect to the terminal 600b connecting to the customer B premises network 110. Also, FIG. 3 illustrates that the customer terminal information database 305 stores the customer ID “200”, the MAC address “CC:DD:EE:56:78:90”, and the terminal ID “2” in association with each other, with respect to the terminal 600c.

In addition, as illustrated in FIG. 3, the same terminal ID (the terminal ID “1”) may be assigned to the terminal (the terminal 600a, the terminal 600b) connecting to the different premises network.

The transfer relay apparatus 302 relays a data transfer process between the terminal information generation apparatus 301 and the policy application apparatus 304. In addition, the transfer relay apparatus 302 relays data transfer process between the address translation apparatus 303 and the policy application apparatus 304. The data to be transferred is assumed to be added with the terminal information.

The address translation apparatus 303 is configured by including an address translation part 3031 and a storage part (a flow information storage part) 3032.

A process of the address translation part 3031 may be realized by a program for causing to execute in the processor (CPU) configuring the address translation apparatus 303. In this case, the program is read from the computer readable medium (the semiconductor memory, the HDD, or the like) storing the program and each the process is executed by the processor configuring a server apparatus.

The storage part 3032 is realized by using a magnetic disk apparatus, an optical disk apparatus, or a semiconductor memory.

The address translation apparatus 303 is a node (second node) which is a boundary between the control system 300 and the internet 401. The address translation apparatus 303 may be realized as NAT (Network Address Translations).

It is assumed that the address translation apparatus 303 receives the data whose transmission source or destination is the terminal 600 from outside of the control system 300. In this case, the address translation apparatus 303 adds, to the received data, the terminal information including the terminal ID corresponding to the terminal 600 which is transmission source or destination of the received data and the customer ID for the customer corresponding to the premises network to which the terminal 600 connects. And, the address translation apparatus 303 transfers the data added with the terminal information to the node (for example, the transfer relay apparatus 302) in the control system 300.

Also, it is assumed that the address translation apparatus 303 receives, from inside of the control system 300, the data added with the terminal information including the number-assigned terminal ID for the terminal 600 which is transmission source or destination of the data and the customer ID for the customer corresponding to the premises network to which the terminal 600 connects. In this case, the address translation apparatus 303 removes the terminal information from the received data and transfers the resultant data to outside of the control system 300 (the internet 401). That is, when the address translation apparatus 303 receives the data added with the terminal information, the address translation apparatus 303 removes the terminal information from the received data and transfers, to the destination of the data, the resultant data from which the terminal information has been removed.

Concretely, it is assumed that the address translation apparatus 303 receives the data transmitted from the terminal 600 in the customer premises network and the data added with the terminal information. In this case, the address translation apparatus 303 stores flow information and the terminal information in the storage part 3032, by associating the terminal information added to the received data with the flow information. And, the address translation apparatus 303 removes the terminal information from the received data and transfers, to destination of the data, the resultant data from which the terminal information is removed.

Hereinafter, it will be explained about the address translation apparatus 303 in more detail.

The address translation part 3031 receives the data (the packet) from outside of the control system 300 (the internet 401). And, the address translation part 3031 executes a translation process between a private IP address used in the customer premises network and a global IP address.

Concretely, when the terminal information generation apparatus 301 receives the data transmitted from the terminal 600 in the customer premises, the address translation part 3031 translates a transmission source IP address (private IP address) to a global IP address.

Also, the address translation part 3031 generates flow information. The flow information is information specifying a flow of communication. Concretely, when the control system 300 receives the data transmitted from the terminal 600 in the customer premises, the address translation part 3031 generates the flow information. For example, the flow information includes a transmission source IP address, a transmission source port, a destination IP address, a destination port, a protocol, or the like.

The address translation part 3031 makes the storage part 3032 store the terminal information and flow information, by associating the terminal information with the flow information.

On the other hand, when the control system 300 receives the data destined to the terminal 600 in the customer premises, the address translation part 3031 translates the destination IP address of the data (the global IP address) to the private IP address.

When the control system 300 receives the data from the internet 401, the address translation part 3031 determines whether or not the data is a response to the data transmitted from the terminal 600 in the customer premises based on the flow information stored in the storage part 3032.

When the data received from the internet 401 is the response to the data transmitted from the terminal 600 in the customer premises, the address translation part 3031 specifies the customer and transmits the response to the terminal 600 in the customer premises.

On the other hand, when the data received from the internet 401 is not the response to the data transmitted from the terminal 600 in the customer premises, the address translation part 3031 discards the data received from the internet 401.

The storage part 3032 stores the flow information. Here, the flow information which the storage part 3032 stores is assumed to be associated with the terminal information. That is, the flow information which the storage part 3032 stores is assumed to be associated with the customer ID and terminal ID.

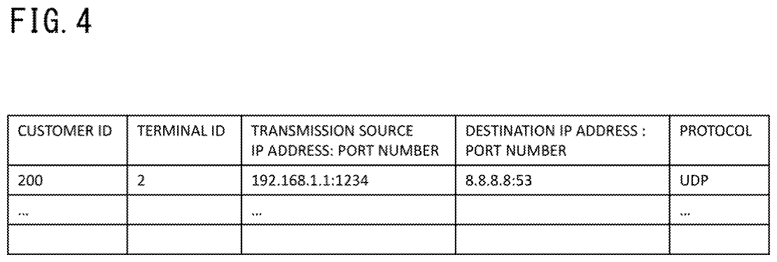

FIG. 4 is a diagram illustrating an example of the information which the storage part 3032 stores. FIG. 4 illustrates that the storage part 3032 stores the customer ID, the terminal ID, information specifying transmission source, information specifying destination, and the protocol in association with each other. As illustrated in FIG. 4, the information specifying the transmission source may be the transmission source IP address and a port number. Similarly, the information specifying the destination may be the destination IP address and the port number.

FIG. 4 illustrates that the transmission source IP address is “192.168.1.1” and the port number of the transmission source is “1234”, with respect to the data transmitted from the terminal 600 that is the customer ID “200” and the terminal ID “2”. In addition, FIG. 4 illustrates that the destination IP address is “8.8.8.8” and the port number of the destination is “53”, with respect to the data transmitted from the terminal 600 that is the customer ID “200” and the terminal ID “2”. In addition, FIG. 4 illustrates that the data transmitted from the terminal 600 which is the customer ID “200” and the terminal ID “2” is transmitted by using a protocol “UDP (User Data Protocol)”.

The policy application apparatus 304 is configured by including a policy application part 3041, a storage part (a policy storage part) 3042, and VNFs (3043, 3044). In addition, FIG. 2 illustrates two VNFs (3043, 3044) as an example, but this does not mean that the number of VNFs is limited to two. The number of VNFs which the policy application apparatus 304 controls may be one, or three or more.

A process of the policy application part 3041 may be realized by using a program executed in the processor (CPU) configuring the policy application apparatus 304. In this case, the program is read from the computer readable medium (semiconductor memory, HDD, or the like) storing the program, and each process is executed by the processor configuring the server apparatus.

The storage part 3042 is realized by using a magnetic disk apparatus, an optical disk apparatus, or a semiconductor memory.

The policy application apparatus 304 is configured by including one or more of virtual machines. The virtual machine is a node (third node) controlling the virtual network function.

The policy application part 3041 applies a prescribed application policy according to the terminal 600 in the customer premises, the terminal 600 corresponding to the data received by the control system 300.

Concretely, the policy application part 3041 searches in the customer terminal information database 305 based on the terminal information added to the data and specifies a MAC address corresponding to the terminal information added to the data. And, the policy application part 3041 searches in the storage part 3042 based on the specified MAC address and specifies an application policy to be applied to the data. The policy application part 3041 executes a process based on the specified application policy.

The application policy is a policy for service provision to the terminal 600 in the customer premises. For example, the application policy may prohibit the terminal to which the application policy is applied from communication to a specified Web site. Also, the application policy may limit a time period of connection to the internet 401, for the terminal to which the application policy is applied. In addition, the application policy exemplified in the present disclosure is an example and it does not mean that the application policy is limited to the processing exemplified in the present disclosure.

The storage part 3042 stores in advance the customer ID, the MAC address of the terminal 600, and the application policy applied to the terminal 600 in association with each other. For example, the storage part 3042 may store a table in which the customer ID, the MAC address, and the application policy applied to the terminal 600 corresponding to the MAC address are associated each other.

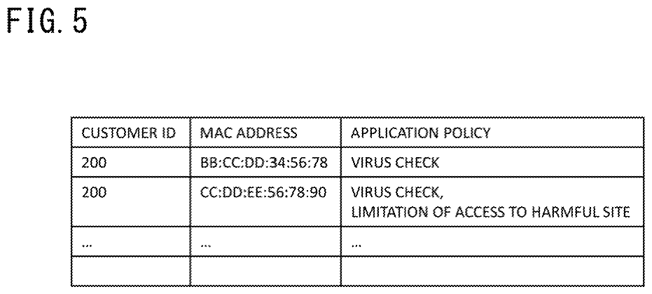

FIG. 5 is a diagram illustrating an example of information which the storage part 3042 stores. FIG. 5 illustrates a table in which the customer ID, the MAC address, and the application policy are associated.

FIG. 5 illustrates that “VIRUS CHECK” is associated with the data which the terminal 600 of the MAC address “BB:CC:DD:34:56:78” connecting to the customer premises network of the customer ID “200” is transmission source or destination. For example, it is assumed that the terminal of the MAC address “BB:CC:DD:34:56:78” connecting to the customer premises network of the customer ID “200” is the terminal 600c. In this case, when the policy application part 3041 refers to the table illustrated in FIG. 5, the policy application part 3041 applies the application policy of “VIRUS CHECK” to the data which the terminal 600 is transmission source or destination.

Similarly, FIG. 5 illustrates that “VIRUS CHECK” and “LIMITATION OF ACCESS TO HARMFUL SITE” are associated with the data whose transmission source or destination is the terminal 600 of the MAC address “CC:DD:EE:56:78:90” connecting to the customer premises network of the customer ID “200”. For example, it is assumed that the terminal of the MAC address “CC:DD:EE:56:78:90” connecting to the customer premises network of the customer ID “200” is the terminal 600b. In this case, when the policy application part 3041 refers to the table illustrated in FIG. 5, the policy application part 3041 applies the application policy of “VIRUS CHECK” and “LIMITATATION OF ACCESS TO HARMFUL SITE” to the data whose transmission source or destination is the terminal 600.

Further, an application policy being “VIRUS CHECK” means that the policy application part 3041 applies a process of discarding data which is determined as virus (in general, when a communication pattern same as a DB storing virus information is included in a customer communication, the data is discarded) to the data to be transmitted and received. Also, an application policy being “LIMITATION OF ACCESS TO HARMFUL SITE” means that the policy application part 3041 disconnects communication (in general, when accessing to a URL existing in a DB storing harmful site information, the customer's communication is disconnected), when the data to be transmitted is data relating a communication determined to be harmful to a child.

Next, it will be explained about operation of the control system 300 in detail.

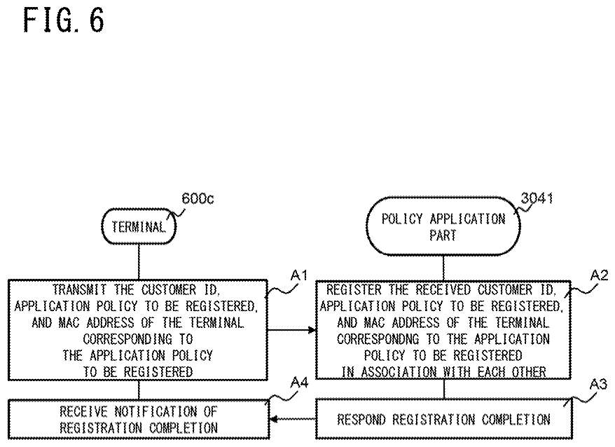

First, referring to FIG. 6, it will be explained with respect to a process of registering the application policy applied to the terminal 600. In FIG. 6, it will be explained, as an example, about the process that the terminal 600c requests the registration of the application policy, however it does not mean that the terminal requesting the registration of the application policy is limited to the terminal 600c.

In Step A1, the terminal 600c transmits, to the policy application part 3041, the customer ID, the application policy to be registered, and the MAC address of the terminal 600 corresponding to the application policy to be registered.

For example, it is assumed that a communication carrier managing the control system 300 provides a Web site available for registration of the application policy. In this case, the customer B logs in to the Web site available for registration of the application policy, by using the terminal 600c in the customer B premises. And, the customer B inputs, to the Web site available for the registration of the application policy, a customer ID for the customer B, an application policy to be registered, and a MAC address of the terminal 600 corresponding to the application policy to be registered.

Here, it is assumed that the customer B sets the application policy corresponding to the terminal 600b connecting to the customer B premises network 110, by using the terminal 600c. It is assumed that the application policy to be registered is the application policy being “VIRUS CHECK” and “LIMITATION OF ACCESS TO HARMFUL SITE”. In this case, the customer B inputs, to the Web site available for the registration of the application policy, the customer ID for the customer B, the application policy being “VIRUS CHECK” and “LIMITATION OF ACCESS TO HARMFUL SITE”, and the MAC address of the terminal 600b, by using the terminal 600c.

In Step A2, the policy application part 3041 registers the received customer ID, the application policy to be registered, and the MAC address of the terminal 600 corresponding to the application policy to be registered in association with each other. The policy application part 3041 makes the storage part 3042 store the received customer ID, the application policy to be registered, and the MAC address of the terminal 600 corresponding to the application policy to be registered in association with each other.

In Step A3, the policy application part 3041 responds registration completion to the terminal 600c. The terminal 600c receives notification of the registration completion (Step A4).

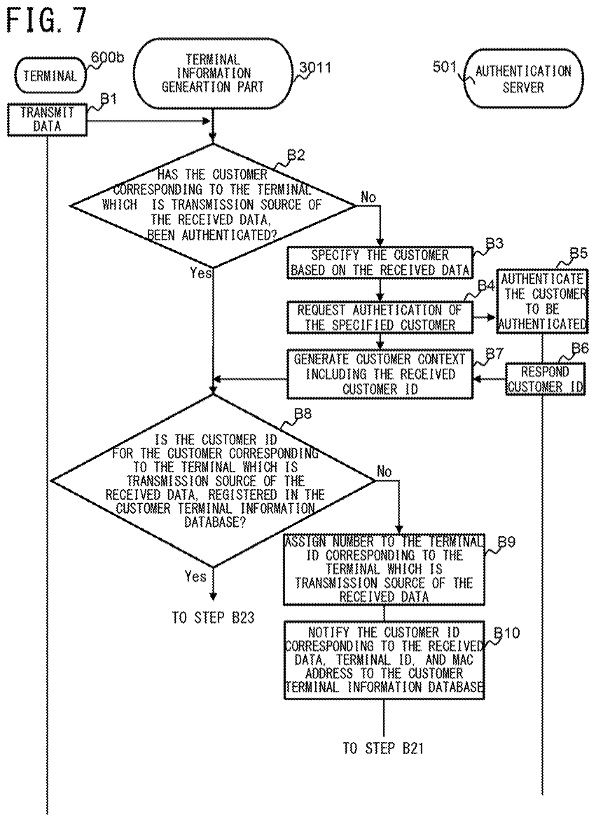

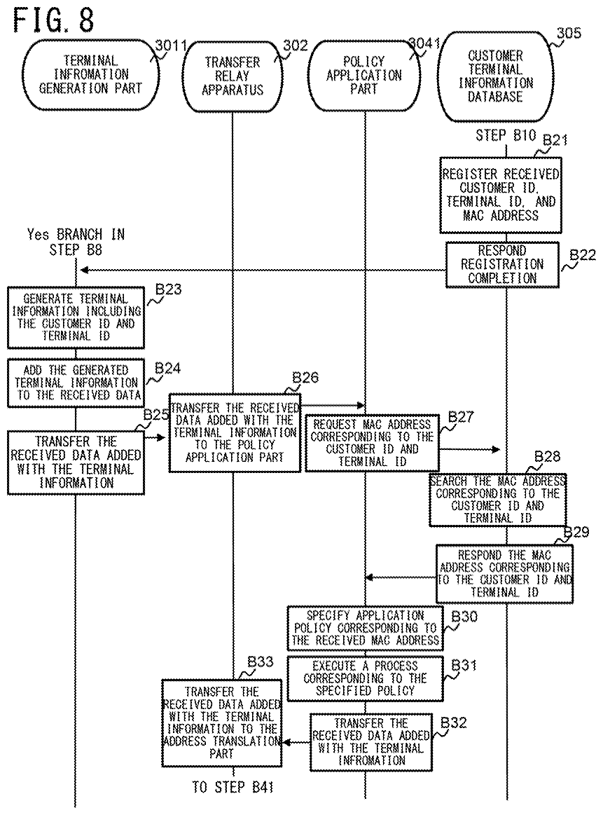

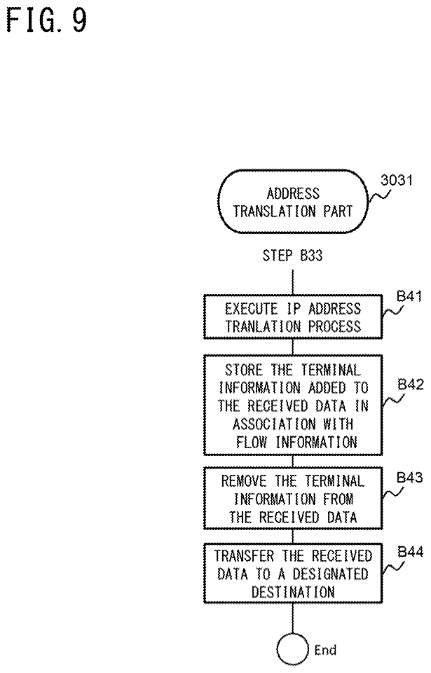

Next, referring to FIG. 7, FIG. 8, and FIG. 9, it will be explained with respect to a process of transmitting the data from the terminal 600b via the control system 300.

First, referring to FIG. 7, it will be explained with respect to the process of transmitting the data from the terminal 600b via the control system 300. In a following explanation, it is assumed that the terminal 600b is the terminal 600 used by a child (for example, a smartphone used by the child). Also, it is assumed that the terminal 600b is associated with the application policy being “VIRUS CHECK” and “LIMITATION OF ACCESS TO HARMFUL SITE” in advance. That is, it is assumed that the storage part 3042 has stored the information associated with the MAC address of the terminal 600b, the customer ID corresponding to the terminal 600b, and the application policy being “VIRUS CHECK” and “LIMITATION OF ACCESS TO HARMFUL SITE”.

The terminal 600b starts a packet communication process via the control system 300. The terminal 600b transmits the data to the control system 300 (Step B1). The terminal information generation part 3011 receives the data from the terminal 600b.

The terminal information generation part 3011 confirms whether or not the customer corresponding to the terminal 600b which is transmission source of the received data has been authenticated (Step B2). Concretely, the terminal information generation part 3011 determines whether or not a customer context corresponding to the customer has been generated. When the terminal information generation part 3011 has generated the customer context corresponding to the customer, the terminal information generation part 3011 determines that the customer has been authenticated. When the terminal information generation part 3011 has not generated the customer context corresponding to the customer, the terminal information generation part 3011 determines that the customer has not been authenticated.

When the customer corresponding to the terminal 600b which is transmission source of the received data has been authenticated (Yes branch in Step B2), the process shifts to Step B8.

On the other hand, when the customer corresponding to the terminal 600b which is transmission source of the data has not been authenticated (No branch in Step B2), the terminal information generation part 3011 specifies the customer based on the received data (Step B3). Concretely, the terminal information generation part 3011 specifies the customer who transmitted the receive data, based on information included in an IP encapsulating header or the like of the received data. Here, the information included in the IP encapsulating header or the like of the receive data may be a VLAN (Virtual Local Area Network) ID, a GRE (Generic Routing Encapsulation) Key ID, a User ID of PPP (Pont-to-Point Protocol), or the like.

The terminal information generation part 3011 requests the authentication of the specified customer to the authentication server 501 (Step B4). When the authentication server 501 receives the authentication request from the terminal information generation part 3011, the authentication server 501 authenticates the customer to be authenticated (Step B5). When the authentication server 501 authenticates the customer, the authentication server 501 responds the customer ID to the terminal information generation part 3011 (Step B6). The terminal information generation part 3011 receives the customer ID form the authentication server 501.

The terminal information generation part 3011 generates a customer context including the received customer ID (Step B7).

In step B8, the terminal information generation part 3011 determines whether or not the customer ID for the customer corresponding to the terminal 600b which is the transmission source of the received data is registered in the customer terminal information database 305. For example, the terminal information generation part 3011 may refer to an Ethernet (registered trademark) header of the received data and specify the terminal 600b in the customer premises based on the MAC address included in the header.

When the customer ID for the customer corresponding to the terminal 600b which is the transmission source of the data is registered in the customer terminal information database 305 (Yes branch in Step B8), the process shifts to Step B23 illustrated in FIG. 8. On the other hand, when the customer ID for the customer corresponding to the terminal 600b which is the transmission source of the data is not registered in the customer terminal information database 305 (No branch in Step B8), the process shifts to B9.

In Step B9, the terminal information generation part 3011 assigns a number to the terminal ID corresponding to the terminal 600b which is the transmission source of the received data. Concretely, the terminal information generation part 3011 assigns a number to the terminal ID unique in the customer B premises network 110.

And, the terminal information generation part 3011 notifies the customer ID corresponding to the received data, the terminal ID, and the MAC address to the customer terminal information database 305 (Step B10). Concretely, the terminal information generation part 3011 requests such that the customer ID corresponding to the received data, the terminal ID, and the MAC address are registered in the customer terminal information database 305. And, the process shifts to B21 illustrated in FIG. 8.

Next, referring to FIG. 8, it will be explained continuously with respect to the process of transmitting the data from the terminal 600b via the control system 300.

In Step B21, the customer terminal information database 305 registers the customer ID, the terminal ID and the MAC address as received (Step B21). And, the customer terminal information database 305 responds registration completion to the terminal information generation part 3011 (Step B22).

In Step B23, the terminal information generation part 3011 generates terminal information including the customer ID and terminal ID.

In Step B24, the terminal information generation part 3011 adds the generated terminal information to the received data. For example, the terminal information generation part 3011 may add the terminal information in a GRE header as a NSH (Next Service Header). Here, use range of the terminal information is in the control system 300. Therefore, a method in which the terminal information generation part 3011 adds the terminal information is not limited to the method in which the terminal information generation part 3011 adds the terminal information as the NSH.

In Step B25, the terminal information generation part 3011 transfers the received data added with the terminal information to the transfer relay apparatus 302. The transfer relay apparatus 302 transfers the received data added with the terminal information to the policy application part 3041 (Step B26).

The policy application part 3041 requests the MAC address corresponding to the customer ID and terminal ID to the customer terminal information database 305 (Step B27). The customer terminal information database 305 searches the MAC address corresponding to the customer ID and terminal ID (Step B28). The customer terminal information database 305 responds the MAC address corresponding to the customer ID and terminal ID to the policy application part 3041 (Step B29).

The policy application part 3041 specifies the application policy corresponding to the received MAC address (Step B30). That is, the policy application part 3041 specifies the application policy corresponding to the terminal 600b which is the transmission source of the received data. And, the policy application part 3041 executes a process corresponding to the specified application policy (Step B31).

For example, it is assumed that the storage part 3042 stores the customer ID, the MAC address and the application policy illustrated in FIG. 5 in association with each other. Here, it is assumed that the MAC address of the terminal 600b is “CC:DD:EE:56:78:90”. In this case, the policy application part 3041 specifies the application policy with “VIRUS CHECK” and “LIMITATION OF ACCESS TO HARMFUL SITE” as the application policy corresponding to the terminal 600b.

And, when the receive data transmitted from the terminal 600b includes the data which is determined as the virus, the policy application part 3041 discards the received data and terminates the communication. Or, when the received data transmitted from the terminal 600b is data of a communication which is determined as harmful to the child, the policy application part 3041 discards the received data and terminates the communication. Here, the communication which is determined as harmful to the child is a case where destination of the received data is the Web site harmful to the child or the like.

Further, it is assumed that transmission source of the received data is the terminal 600c. And, it is assumed that the MAC address of the terminal 600c is “BB:CC:DD:34:56:78”. In this case, the policy application part 3041 specifies the application policy being “VIRUS CHECK” as the application policy corresponding to the terminal 600c.

Therefore, when the received data transmitted from the terminal 600c includes the data which is determined as the virus, the policy application part 3041 discards the received data and terminates the communication. However, even if the received data transmitted from the terminal 600c is the data of the communication which is determined as harmful to the child, the policy application part 3041 continues the communication.

In Step B32, the policy application part 3041 transfers the received data added with the terminal information to the transfer relay apparatus 302. The transfer relay apparatus 302 transfers the received data added with the terminal information to the address translation part 3031 (Step B33). And, the process shifts to Step B41 illustrated in FIG. 9.

Next, referring to FIG. 9, it will be explained continuously with respect to the process of transmitting the data from the terminal 600b via the control system 300.

In Step B41, the address translation part 3031 executes the IP address translation process. Concretely, the address translation part 3031 translates the private IP address used in the customer B premises network 110 to the global IP address. Here, as explained above, the address translation apparatus 303 may be realized as the NAT.

The address translation part 3031 stores, in the storage part 3032, information specifying a flow of communication as flow information.

In Step B42, the address translation part 3031 stores, in the storage part 3032, the terminal information added to the received data in association with the flow information.

In Step B43, the address translation part 3031 removes the terminal information from the received data. The address translation part 3031 transfers the received data to a designated destination (Step B44). Concretely, the address translation part 3031 transfers the received data to the internet 401.

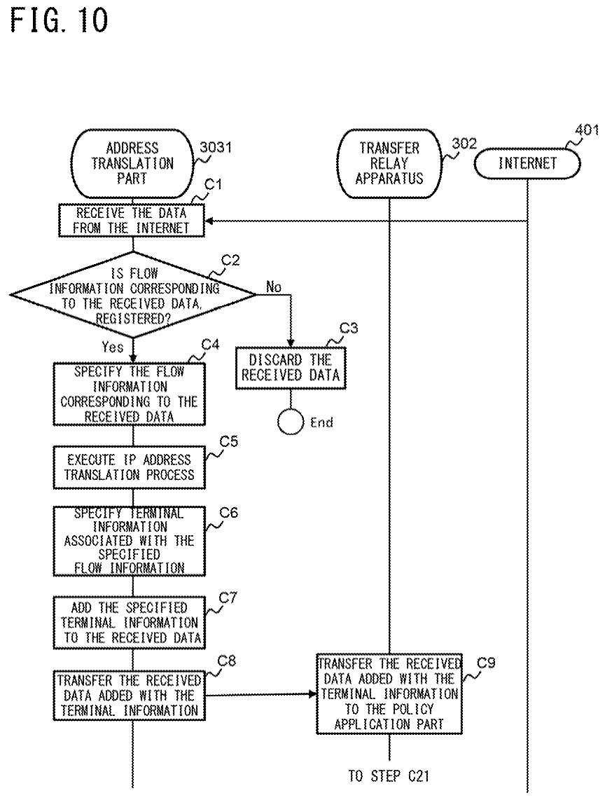

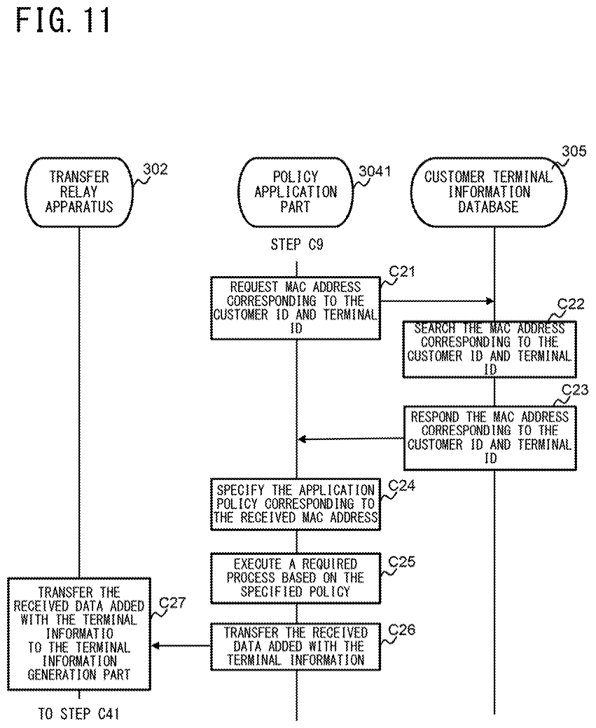

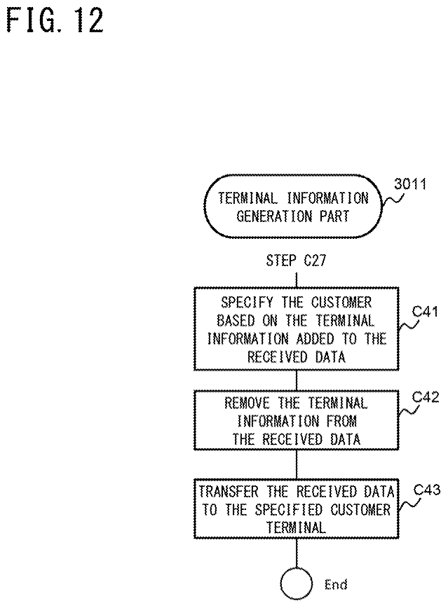

Next, referring to FIG. 10, FIG. 11 and FIG. 12, it will be explained with respect to the process in which the control system 300 transmits the data to the terminal 600b.

First, referring to FIG. 10, it will be explained with respect to the process in which the control system 300 transmits the data to the terminal 600b.

In Step C1, the address translation part 3031 receives the data from the internet 401.

In Step C2, the address translation part 3031 determines whether or not flow information corresponding to the received data is stored.

When the flow information corresponding to the received data is not stored (No branch in Step C2), the address translation part 3031 discards the received data (Step C3). That is, when the received data is not a response to the data transmitted from the terminal 600 in the customer premises, the address translation part 3031 discards the received data. And, the process in which the control system 300 transmits the data to the terminal 600b terminates.

On the other hand, the flow information corresponding to the received data is stored (Yes branch in Step C2), the address translation part 3031 specifies the flow information corresponding to the received data (Step C4). For example, the address translation part 3031 refers to the storage part 3032 and specifies the flow information corresponding to the received data.

In Step C5, the address translation part 3031 executes an IP address translation process. Concretely, the address translation part 3031 translates a global IP address corresponding to the received data to a private IP address used in the customer B premises network 110.

In Step C6, the address translation part 3031 specifies terminal information associated with the specified flow information. And, the address translation part 3031 adds the specified terminal information to the received data (Step C7).

In Step C8, the address translation part 3031 transfers the received data added with the terminal information to the transfer relay apparatus 302. The transfer relay apparatus 302 transfers the received data added with the terminal information to the policy application part 3041 (Step C9). And, the process shifts to Step C21 illustrated in FIG. 11.

Next, referring to FIG. 11, it will be explained continuously with respect to the process in which the control system 300 transmits the data to the terminal 600b.

In Step C21, the policy application part 3041 requests a MAC address corresponding to the customer ID and terminal ID to the customer terminal information database 305. The customer terminal information database 305 searches the MAC address corresponding to the customer ID and terminal ID (Step C22). The customer terminal information database 305 responds the MAC address corresponding to the customer ID and terminal ID to the policy application part 3041 (Step C23).

The policy application part 3041 specifies the application policy corresponding to the received MAC address. That is, the policy application part 3041 specifies the application policy corresponding to the terminal 600b which is destination of the received data. And, the policy application part 3041 executes a process corresponding to the specified application policy (Step C25).

For example, it is assumed that the storage part 3042 stores the customer ID, MAC address and application policy illustrated in FIG. 5 in association with each other. Here, it is assumed that the MAC address of the terminal 600b is “CC:DD:EE:56:78:90”. In this case, the policy application part 3041 specifies the application policy being “VIRUS CHECK” and “LIMITATION OF ACCESS TO HARMFUL SITE” as the application policy corresponding to the terminal 600b.

And, when the received data destined to the terminal 600b includes the data which is determined as the virus, the policy application part 3041 discards the received data and terminates the communication. Or, when the received data destined to the terminal 600b is the data of the communication which is determined as harmful to the child, the policy application part 3041 discards the received data and terminates the communication. Here, the communication which is determined as harmful to the child is a case where the transmission source of the received data is a Web site harmful to the child, or the like.

Further, it is assumed that the destination of the received data is terminal 600c. And, it is assumed that the MAC address of the terminal 600c is “BB:CC:DD:34:56:78”. In this case, the policy application part 3041 specifies the application policy being “VIRUS CHECK” as an application policy corresponding to the terminal 600c.

Therefore, when the received data destined to the terminal 600c includes the data which is determined as the virus, the policy application part 3041 discards the received data and terminates the communication. However, even if the received data destined to the terminal 600c is the data of the communication which is determined as harmful to the child, the policy application part 3041 continues the communication.

In Step C26, the policy application part 3041 transfers the received data added with the terminal information to the transfer relay apparatus 302. The transfer relay apparatus 302 transfers the received data added with the terminal information to the terminal information generation part 3011. And, the process shifts Step C41 illustrated in FIG. 12.

Next, referring to FIG. 12, it will be explained with respect to the process in which the control system 300 transmits the data to the terminal 600b.

In Step C41, the terminal information generation part 3011 specifies the customer based on the terminal information added to the received data.

In Step C42, the terminal information generation part 3011 removes the terminal information from the received data. The terminal information generation part 3011 transfers the received data to the specified customer terminal 600 (terminal 600b) (Step C43). And, the control system 300 terminates the process of transmitting the data to the terminal 600b.

### MODIFIED EXAMPLE 1

As Modified Example 1 of the control system 300 according to the present exemplary embodiment, the policy application part 3041 may comprise a cache memory. And, the cache memory of the policy application part 3041 may store the customer terminal information database 305. In this case, when the policy application part 3041 acquires the MAC address from the customer terminal information database 305, it contributes to reduce overhead with respect to communication speed.

### MODIFIED EXAMPLE 2

As Modified Example 2 of the control system 300 according to the present exemplary embodiment, when the policy application apparatus 304 cannot interpret a header of an IP encapsulating, the transfer relay apparatus 302 may notify information identifying the terminal 600 to the policy application apparatus 304, by using a format different from the header of the IP encapsulating.

For example, it is assumed that the transfer relay apparatus 302 receives the data added with the terminal information as a header of the IP encapsulating from the terminal information generation part 3011 or the address translation part 3031. In this case, the transfer relay apparatus 302 may remove the header of the IP encapsulating added to the received data and transfer the resultant data to the policy application part 3041. In this case, the transfer relay apparatus 302 may determine a temporary transmission source IP address different from each of the terminal 600 and notify the determined transmission source IP address to the policy application part 3041. After that, when the transfer relay apparatus 302 receives the data from the policy application part 3041, the transfer relay apparatus 302 may add the terminal information to the received data again and transfer the received data to a designated transfer destination (the terminal information generation part 3011 or the address translation part 3031).

### MODIFIED EXAMPLE 3

As Modified Example 3 of the control system 300 according to the present exemplary embodiment, the control system 300 may be configured by including a router. For example, the control system 300 may be configured by including the router among the terminal information generation apparatus 301, the transfer relay apparatus 302, the address translation apparatus 303 and the policy application apparatus 304. By including the terminal information in the IP encapsulating header in the control system 300, even if the control system 300 is configured by including the router, it is possible to use the data added with the terminal information in the control system 300.

### MODIFIED EXAMPLE 4

As Modified Example 4 of the control system 300 according to the present exemplary embodiment, the address translation apparatus 303 may store an address translation rule different from each of the terminal 600 in the storage part 3032. In this case, the address translation part 3031 may select an address translation rule corresponding to the received data, from registered address translation rules in advance, based on the terminal information added to the received data. And, the address translation part 3031 may execute address translation based on the selected address translation rule.

As explained above, the control system 300 according to the present exemplary embodiment adds the terminal information including the customer ID and terminal ID to the data received from outside the control system 300, and uses the data added with the terminal information in the control system 300. Therefore, the control system 300 according to the present exemplary embodiment, in the control system 300, can store the information identifying each of the terminal 600 connecting to the customer premises network. Accordingly, the control system 300 according to the present exemplary embodiment contributes to identify each of the terminal 500 in the customer premises properly, in the system realized by using the NFV technology.

Further, the control system 300 according to the present exemplary embodiment stores in advance the application policy (or policies) according to the terminal 600, and when the control system 300 receives the data corresponding to the terminal 600 in the customer premises, the control system 300 applies the application policy according to the terminal 600. Therefore, the control system 300 according to the present exemplary embodiment contributes to provide properly the service according to each of the terminal 600 in the customer premises.

A part or all of the above exemplary embodiment(s) can be described as in a following mode(s), but is not limited to the followings.

(Mode 1) It is as the node according to the first aspect.

(Mode 2) It is as the node according to the second aspect

(Mode 3) It is as the control system according to the third aspect.

(Mode 4) The control system preferably according to Mode 3 further comprising a customer terminal information database which stores in advance a customer ID for a customer, a terminal ID corresponding to a terminal in a customer premises network, and a MAC (Media Access Control) address of the terminal corresponding to the terminal ID in association with each other, and further including a third node, wherein the third node including a policy storage part which stores in advance the customer ID, the MAC address of the terminal, and an application policy to be applied to the terminal in association with each other, and a policy application part which searches in the customer terminal information database based on the terminal information added to the data, identifies the MAC address corresponding to the terminal information added to the data, searches in the policy storage part based on the identified MAC address, and identifies the application policy to be applied to the data, wherein the policy application part executes a process based on the identified application policy.

(Mode 5) The control system preferably according to Mode 4, wherein the policy application part comprises a cache memory, and stores the customer terminal information database in the cache memory.

(Mode 6) The control system preferably according to any one of Modes 3 to 5, further comprising; a second node which transfers data to outside of the control system, wherein when the second node receives data to which the terminal information is added, the second node removes the terminal information from the received data and transfers the resultant data from which the terminal information has been removed to destination of the data.

(Mode 7) The control system preferably according to Mode 6, further comprising: a flow information storage part, wherein when the second node receives data transmitted from a terminal in a customer premises network and the data to which the terminal information is added, the second node associates the terminal information added to the received data to flow information, stores the flow information and terminal information in the flow information storage part, removes the terminal information from the received data, and transfers the resultant data from which the terminal information has been removed to the destination of the data.

(Mode 8) The control system preferably according to Mode 7, wherein when the second node receives data destined to the terminal in the customer premises network, the second node identifies the terminal information and adds the identified terminal information to the received data, based on the flow information corresponding to the received data.

(Mode 9) The control system preferably according to Mode 8, wherein when the second node receives the data destined to the terminal in the customer premises network, the second node adds the identified terminal information to the received data and transfers the resultant data to which the terminal information has been added to the first node, and when the first node receives the data transferred from the second node, the first node removes the terminal information from the received data and transfers the resultant data from which the terminal information has been removed to the destination of the data.

(Mode 10) It is as the communication control method according to the fourth aspect.

(Mode 11) It is as the program according to the fifth aspect.

Further, it is assumed that the above patent literatures are incorporated by reference in the present application. Within the entire disclosure of the present invention (including claims), and based on the basic technical concept, it is possible to change and adjust the exemplary embodiments. Also, various combinations or selections (including partial removal) of different disclosed elements (including each element of each claim, each element of each exemplary embodiment, each element of each figure, or the like) within the entire disclosure of the present invention are possible. That is, in the present invention, it is obvious to include various variations or modifications that could be made by a person skilled in the art according to the entire disclosure including claims and the technical concept. Especially, even if there is no explicit description with respect to any number or a small range included in a numerical range described in the present application, it should be interpreted as concretely described about the numerical range described in the present application. When algorithm, software, a flowchart, or an automated process step is showed in the present invention, it is evident that a computer is used, and it is evident that the processor and memory, or the storage apparatus is installed in the computer. Accordingly, even if there is no explicit description, it is understood that these elements are described in the present application of course.

### SIGNS LIST

1 first node
10 control system
20 control apparatus
21, 22 VNF
30 customer premises network
31, 32, 33, 600, 600a, 600b, 600c terminal
100 customer A premises network
101, 111 CPE
201 access/aggregation network
300 control system
301 terminal information generation apparatus
302 transfer relay apparatus
303 address translation apparatus
304 policy application apparatus
305 customer terminal information database
401 internet
501 authentication server
1000 communication system
3011 terminal information generation part
3031 address translation part
3032, 3042 storage part
3041 policy application part

What is claimed is:

1. A node, wherein;
the node is arranged in a control system configured by including a control apparatus controlling a virtual network function(s);
the node assigns a number to a terminal ID (identifier) for a terminal in a customer premises network; and
when the node receives data whose transmission source or destination is a terminal from outside of the control system, the node adds, to the received data, terminal information including a terminal ID corresponding to the terminal which is transmission source or destination of the received data and a customer ID for a customer corresponding to a premises network to which the terminal connects, and transfers the resultant data added with the terminal information to a node inside of the control system.

2. The node according to claim 1, wherein
when the node receives, from inside of the control system, data to which terminal information is added, the terminal information including a number-assigned terminal ID for a terminal that is transmission source or destination of the data and a customer ID for a customer corresponding to a premises network to which the terminal connects, the node removes the terminal information from the received data and transfers the resultant data to outside of the control system.

3. A control system configured by including a control apparatus controlling a virtual network function(s), wherein the system comprises:
a first node that assigns a number to a terminal ID for a terminal in a customer premises network,
when the first node receives data whose transmission source or destination is the terminal from outside of the control system, the first node adds, to the received data, terminal information including a terminal ID corresponding to the terminal which is transmission source or destination of the received data and a customer ID for a customer corresponding to the premises network to which the terminal connects, and
the first node uses the data added with the terminal information in the control system.

4. The control system according to claim 3, further comprising:
a customer terminal information database which stores in advance a customer ID for a customer, a terminal ID corresponding to a terminal in a customer premises network, and a MAC (Media Access Control) address of the terminal corresponding to the terminal ID in association with each other; and
a third node, wherein
the third node including: a policy storage part which stores in advance the customer ID, the MAC address of the terminal, and an application policy to be applied to the terminal in association with each other, and
a policy application part which searches in the customer terminal information database based on the terminal information added to the data, identifies a MAC address corresponding to the terminal information added to the data, searches in the policy storage part based on the identified MAC address, and identifies the application policy to be applied to the data, wherein
the policy application part executes a process based on the identified application policy.

5. The control system according to claim 4, wherein
the policy application part comprises a cache memory, and stores the customer terminal information database in the cache memory.

6. The control system according to claim 3, further comprising:
a second node which transfers data to outside of the control system, wherein
when the second node receives data to which the terminal information is added, the second node removes the terminal information from the received data and transfers the resultant data from which the terminal information has been removed to the destination of data.

7. The control system according to claim 6, further comprising:
a flow information storage part, wherein
when the second node receives data transmitted from a terminal in a customer premises network and the data to which the terminal information is added, the second node associates the terminal information added to the received data to flow information, stores the flow information and the terminal information in the flow information storage part, removes the terminal information from the received data, and transfers the resultant data from which the terminal information has been removed to the destination of data.

8. The control system according to claim 7, wherein
when the second node receives data destined to a terminal in a customer premises network, the second node identifies the terminal information and adds the identified terminal information to the received data, based on the flow information corresponding to the received data.

9. The control system according to claim 8, wherein
when the second node receives data destined to a terminal in a customer premises network, the second node adds the identified terminal information to the received data and transfers the resultant data to which the terminal information has been added to the first node, and when the first node receives data transferred from the second node, the first node removes the terminal information from the received data and transfers the resultant data from which the terminal information has been removed, to the destination of data.

10. A communication control method for controlling a control system controlling a virtual network function(s),
the control system including a first node that receives data whose transmission source or destination is a terminal in a customer premises network, from outside of the control system,
the method comprising:
assigning a number to a terminal ID for the terminal;
generating terminal information including the terminal ID and a customer ID for a customer corresponding to a premises network which is transmission source or destination of the received data;
adding the terminal information to the received data; and
transferring the resultant data to which the terminal information has been added to a node inside of the control system.

11. (canceled)

12. The control system according to claim 4, further comprising:
a second node which transfers data to outside of the control system, wherein
when the second node receives data to which the terminal information is added, the second node removes the terminal information from the received data and transfers the resultant data from which the terminal information has been removed to the destination of data.

13. The control system according to claim 5, further comprising:
a second node which transfers data to outside of the control system, wherein
when the second node receives data to which the terminal information is added, the second node removes the terminal information from the received data and transfers the resultant data from which the terminal information has been removed to the destination of data.

14. The method according to claim 10, wherein the control system further comprises:
a customer terminal information database which stores in advance a customer ID for a customer, a terminal ID corresponding to a terminal in a customer premises network, and a MAC (Media Access Control) address of the terminal corresponding to the terminal ID in association with each other; and
a third node, wherein
the third node including: a policy storage part which stores in advance the customer ID, the MAC address of the terminal, and an application policy to be applied to the terminal in association with each other, and
a policy application part which searches in the customer terminal information database based on the terminal information added to the data, identifies a MAC address corresponding to the terminal information added to the data, searches in the policy storage part based on the identified MAC address, and identifies the application policy to be applied to the data, wherein
the policy application part executes a process based on the identified application policy.

15. The method according to claim 14, wherein
the policy application part comprises a cache memory, and stores the customer terminal information database in the cache memory.

16. The method according to claim 10, wherein the control system further comprises:
a second node which transfers data to outside of the control system, wherein
when the second node receives data to which the terminal information is added, the second node removes the terminal information from the received data and transfers the resultant data from which the terminal information has been removed to the destination of data.

17. The method according to claim 16, wherein the control system further comprises:
a flow information storage part, wherein
when the second node receives data transmitted from a terminal in a customer premises network and the data to which the terminal information is added, the second node associates the terminal information added to the received data to flow information, stores the flow information and the terminal information in the flow information storage part, removes the terminal information from the received data, and transfers the resultant data from which the terminal information has been removed to the destination of data.

18. The method according to claim 17, wherein
when the second node receives data destined to a terminal in a customer premises network, the second node identifies the terminal information and adds the identified terminal information to the received data, based on the flow information corresponding to the received data.

19. The method according to claim 18, wherein
when the second node receives data destined to a terminal in a customer premises network, the second node adds the identified terminal information to the received data and transfers the resultant data to which the terminal information has been added to the first node, and when the first node receives data transferred from the second node, the first node removes the terminal information from the received data and transfers the resultant data from which the terminal information has been removed, to the destination of data.
